(19) United States
(12) Patent Application Publication
(10) Pub. No.: US 2004/0141127 A1
(43) Pub. Date: Jul. 22, 2004

(54) Liquid crystal display

(76) Inventors: Yaw-Ming Tsai, Taichung (TW); I-Min Lu, Taipei (TW); Shih-Chang Chang, Hsinchu (TW)

Correspondence Address: Michael Bednarek, Shaw Pittman LLP, 1650 Tysons Blvd., McLean, VA, 22102-4859, US

(21) Appl. No.: 10/754,563

(22) Filed: Jan. 12, 2004

(30) Foreign Application Priority Data
Jan. 13, 2003 (TW) 92100646

(51) Int. Cl. G02F 1/1335

(52) U.S. Cl. 349/137

(57) ABSTRACT

A liquid crystal display (LCD) of reduced reflection phenomenon is provided. The data lines and gate lines of the LCD have an anti-reflection layer thereon. The anti-reflection layer decreases ambient light reflection. Thus, the CONTRAST of the LCD is improved.

### CROSS REFERENCE TO RELATED APPLICATIONS

This application claims priority of Taiwan Patent Application Serial No. 092100646 filed on Jan. 13, 2003.

### FIELD OF INVENTION

The present invention relates to a liquid crystal display (LCD) of reduced reflection phenomenon.

### BACKGROUND OF THE INVENTION

The reflection of ambient light from an LCD panel would reduce CONTRAST of the liquid crystal display. To increase the CONTRAST, a black matrix layer is disposed inside the liquid crystal display to block the ambient light. The black matrix layer may also cover the area where the liquid crystal is not ordered enough to elevate image quality.

FIG. 1 shows a cross-sectional diagram of a liquid crystal display according to the prior art. A polysilicon layer 128 and an insulator layer 106 are disposed on a first substrate 102. A gate 126 is formed by an extension of a gate line (not shown). An interlayer dielectric layer 108 is formed on the gate 126 and the insulator layer 106. Source/drains 122, 124 are selectively formed by an extension of a data line (not shown). The source/drains 122, 124 are disposed on the interlayer dielectric layer 108 and contact the polysilicon layer 128. The source/drains 122, 124 and the gate 126 form a transistor. A planarization layer 110 is formed on the interlayer dielectric layer 108 and the source/drains 122, 124. A pixel electrode 112 is formed on the planarization layer 110, and electrically connected to the source/drain 124. Color filters 114 are disposed on a second substrate 104. A black matrix layer 120 is located on the second substrate 104 and lies between the color filters 114. A liquid crystal layer 118 is located between the pixel electrode 112 and color filters 114.

The source/drains 122, 124 and the gate 126 are typically formed by metal, which generally has high reflectivity. The first substrate 102 has to be aligned with the second substrate 104 to ensure that the source/drains 122, 124 and the gate 126 are covered by the black matrix layer 120, so that reflection phenomenon is reduced. To cover the source/drains 122, 124 and the gate 126 effectively, typically, the area of the black matrix layer 120 is large. However, larger black matrix area would result in smaller aperture ratio.

### SUMMARY OF THE INVENTION

One aspect of the present invention provides a liquid crystal display having anti-reflection layer for reducing reflection phenomenon of the liquid crystal display.

A liquid crystal display of reduced reflection phenomenon, including a first substrate and a second substrate, is provided. A switch is disposed on the first substrate to control brightness of the liquid crystal display. A data line has an extension to selectively form source/drains of the switch. A first electrode is electrically connected to the data line. An anti-reflection layer of an anti-reflection material is disposed on the data line to reduce reflection phenomenon of the liquid crystal display. A second electrode is disposed on the second substrate. And a liquid crystal layer is disposed between the second electrode and the switch.

A liquid crystal display of reduced reflection phenomenon, including a first substrate and a second substrate, is provided. A switch is disposed on the first substrate to control brightness of the liquid crystal display. A gate line has an extension to form a gate of the switch. A first electrode is electrically connected to the data line. An anti-reflection layer of an anti-reflection material is disposed on the gate line to reduce reflection phenomenon of the liquid crystal display. A second electrode is disposed on the second substrate. And a liquid crystal layer is disposed between the second electrode and the switch.

### BRIEF DESCRIPTION OF THE DRAWINGS

For a more complete understanding of the present invention, and the advantage thereof, reference is now made to the following descriptions taken in conjunction with the accompanying drawings, in which:

FIG. 1 is a cross-sectional diagram of a liquid crystal display according to the prior art, which has a black matrix layer and a data line;

FIG. 2 is a schematic diagram showing a relative position of a data line and a gate line of an exemplary embodiment;

FIG. 3 is a cross-sectional diagram of a first exemplary embodiment, in which a data line has an anti-reflection layer and a color filter is disposed on a second substrate;

FIG. 4 is a cross-sectional diagram of a second exemplary embodiment, in which a data line has an anti-reflection layer and a color filter is disposed on a first substrate;

FIG. 5 is a cross-sectional diagram of a third exemplary embodiment, in which a data line has an anti-reflection layer and a color filter is disposed on a first substrate;

FIG. 6 is a cross-sectional diagram of a fourth exemplary embodiment, in which a gate line has an anti-reflection layer; and

FIG. 7 is a cross-sectional diagram of a fifth exemplary embodiment, in which both a data line and a gate line have an anti-reflection layer.

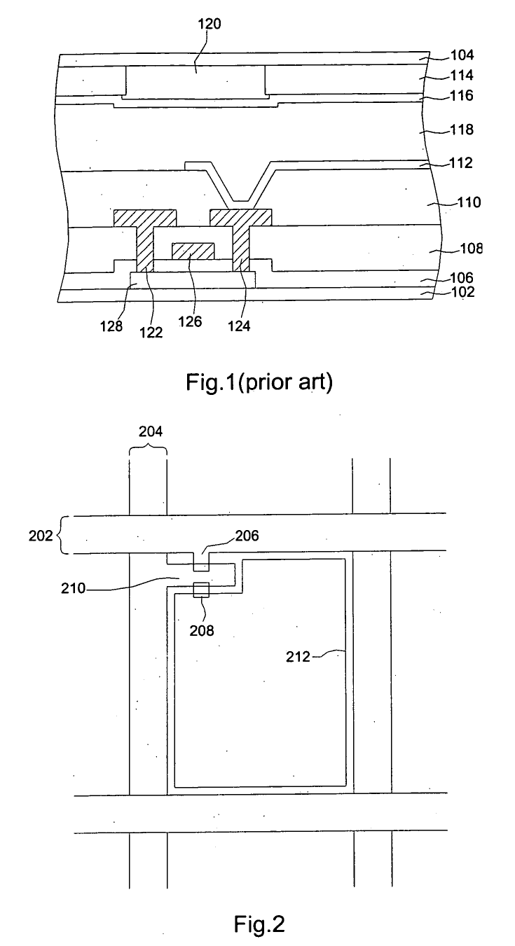

### DETAILED DESCRIPTION

A liquid crystal display having an anti-reflection layer is provided. The anti-reflection layer is disposed on a data line or a gate line to reduce reflection phenomenon and elevate CONTRAST.

FIG. 2 is a schematic diagram showing a relative position of a data line and a gate line of an exemplary embodiment. The data line 202 and the gate line 204 are staggered to each other. The data line 202 has an extension to selectively form source/drains 206, 208. The gate line 204 has an extension to form a gate 210. A pixel electrode 212 is electrically connected to the source/drain 208. The anti-reflection layer of the present invention may be formed on one of or both the data line 206 and the gate line 208.

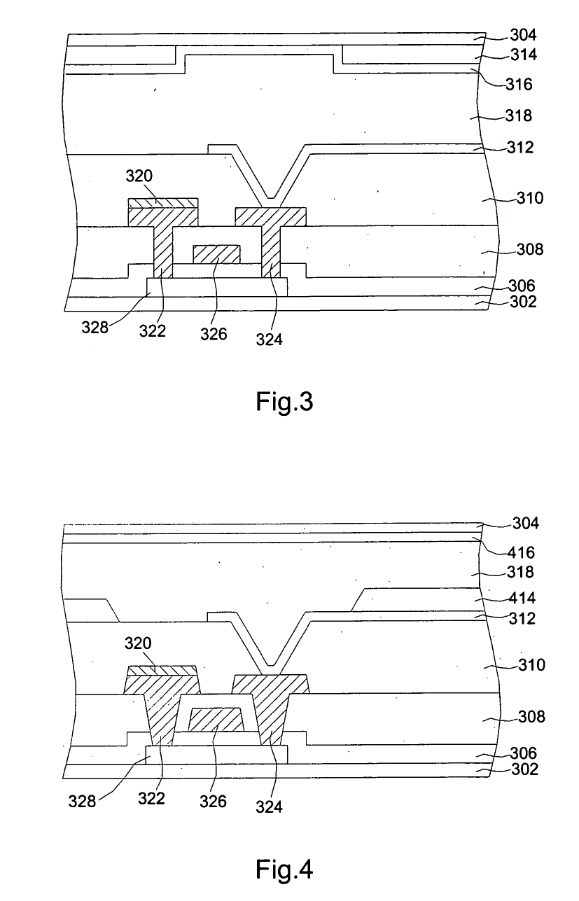

FIG. 3 is a cross-sectional diagram of a first exemplary embodiment. The first substrate 302 and the second substrate 304 may be glass substrates or similar. A semiconductor layer 328, preferably being a polysilicon layer or an amorphous silicon layer, is disposed on the first substrate 302. An insulator layer 306 is located on the semiconductor layer 328. A gate 326 formed by an extension of a gate line is disposed on the insulator layer 306. An interlayer dielectric layer 308 is formed on the gate 326 and the first substrate 302. Source/drains 322, 324 selectively formed by an extension of the data line, are disposed on the interlayer dielectric layer 308 and contact the semiconductor layer 328. The gate 326, the source/drains 322, 324 form a switch, e.g. thin film transistor. A planarization layer 310 is formed on the interlayer dielectric layer 308 and the source/drains 322, 324. A first electrode 312, namely pixel electrode, is formed on the planarization layer 310 and electrically connected to the source/drain 324. The first electrode 312 is preferably composed of Indium Tin Oxide (ITO), Indium Zinc Oxide (IZO), or similar.

With continued reference to FIG. 3, an anti-reflection layer 320 is disposed on the source/drain 322. The anti-reflection layer 320 has the same pattern as the data line and the source/drain 322. Therefore, no additional optical mask is needed to fabricate the anti-reflection layer 320. The anti-reflection layer 320 is composed of anti-reflection material, which may reduce reflection inside the liquid crystal display. The anti-reflection material may preferably be chromium oxide, silicon nitride, or other appropriate reflection-reducing material. Color filters 314 may be formed on the second substrate 304 to form color display. A second electrode 316 is formed on the color filters 314. The second electrode 316, also known as common electrode, is preferably composed of ITO or similar. A liquid crystal layer 318 is located between the second electrode 316 and the planarization layer 310. In the first exemplary embodiment, the anti-reflection layer 320 is formed directly on the source/drain 322. Therefore, no excess area of the anti-reflection layer 320 is needed to cover the source/drain 322, and the aperture ratio may be effectively raised.

FIG. 4 is a cross-sectional diagram of a second exemplary embodiment. The main difference between the first and second exemplary embodiments is that the color filter 414 is formed directly on the first electrode 312. As shown in FIG. 4, the first electrode 312 is located between the color filter 414 and the planarization layer 310. And the second electrode 416 is formed directly on the second substrate 304. In the second exemplary embodiment, the color filter 414 is formed directly on the first electrode 312. Therefore, it would not be necessary to align the color filter 414 with the first substrate 302, which is required for the first exemplary embodiment.

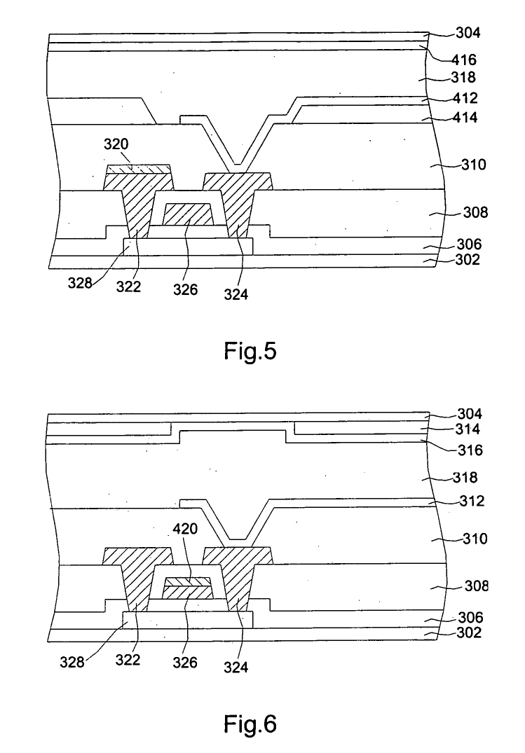

FIG. 5 is a cross-sectional diagram of a third exemplary embodiment. The main differences between the second and third exemplary embodiments are that the color filter 414 is formed directly on the planarization layer 310 and the first electrode 412 is formed on the color filter 414.

FIG. 6 is a cross-sectional diagram of a fourth exemplary embodiment. The main difference between the first and fourth exemplary embodiments is that the anti-reflection layer 420 is formed on the gate 326. The anti-reflection layer 420 is composed of anti-reflection material, which may reduce reflection inside the liquid crystal display. The anti-reflection material may preferably be chromium oxide, silicon nitride, or other appropriate reflection-reducing material. The anti-reflection layer 420 has the same pattern as the gate line and the gate 326. Therefore, no additional optical mask is needed to fabricate the anti-reflection layer 420. For the fourth exemplary embodiment, the color filter 314 may also locate directly on the first electrode 312 or the planarization layer 310, as shown in FIG. 4 and FIG. 5.

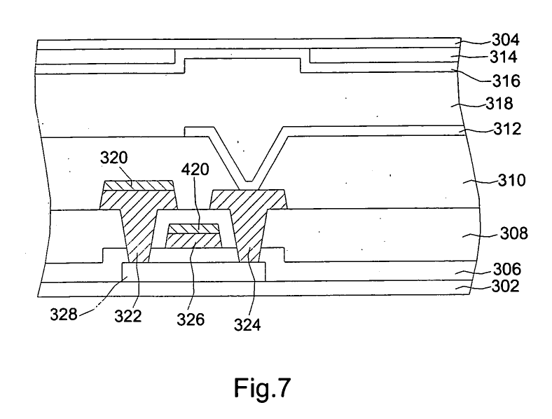

FIG. 7 is a cross-sectional diagram of a fifth exemplary embodiment. Being different from the first and fourth exemplary embodiments, both anti-reflection layers 320 and 420 are formed. Then the reflection inside the liquid crystal display is effectively reduced and the CONTRAST is elevated. For the fifth exemplary embodiment, the color filter 314 may also locate directly on the first electrode 312 or the planarization layer 310, as shown in FIG. 4 and FIG. 5.

Though the embodiments described herein adopt the top-gate structure, other structures, such as the bottom-gate structure, may still be suitable for this invention.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A liquid crystal display of reduced reflection phenomenon, comprising:
a first substrate and a second substrate;
a switch, disposed on said first substrate, for controlling a brightness of said liquid crystal display;
a data line having an extension to selectively form source/drains of said switch;
a first electrode electrically connected to said data line;
an anti-reflection layer of an anti-reflection material, said anti-reflection layer being disposed on said data line to reduce reflection of said liquid crystal display;
a second electrode disposed on said second substrate; and
a liquid crystal layer disposed between said second electrode and said switch.

2. The liquid crystal display of claim 1, wherein said anti-reflection material is selected from the group consisting of chromium oxide, silicon nitride and the combination thereof.

3. The liquid crystal display of claim 1, wherein said first electrode is selected from the group consisting of Indium Tin Oxide (ITO), Indium Zinc Oxide (IZO) and the combination thereof.

4. The liquid crystal display of claim 1, further comprising a color filter disposed between said second substrate and said liquid crystal layer.

5. The liquid crystal display of claim 1, further comprising a color filter disposed between said switch and said liquid crystal layer, and said first electrode being disposed between said color filter and said switch.

6. The liquid crystal display of claim 1, further comprising a color filter disposed between said switch and said liquid crystal layer, and said first electrode being disposed between said color filter and said liquid crystal layer.

7. A liquid crystal display of reduced reflection phenomenon, comprising:
a first substrate and a second substrate;
a switch, disposed on said first substrate, for controlling a brightness of said liquid crystal display;
a gate line having an extension to form a gate of said switch;
an anti-reflection layer of an anti-reflection material, said anti-reflection layer being disposed on said gate line to reduce reflection of said liquid crystal display;
a second electrode disposed on said second substrate; and
a liquid crystal layer disposed between said second electrode and said switch.

8. The liquid crystal display of claim 7, wherein said anti-reflection material is selected from the group consisting of chromium oxide, silicon nitride and the combination thereof.

9. The liquid crystal display of claim 7, wherein said first electrode is selected from the group consisting of Indium Tin Oxide (ITO), Indium Zinc Oxide (IZO) and the combination thereof.

10. The liquid crystal display of claim 7, further comprising a color filter disposed between said second electrode and said liquid crystal layer.

11. The liquid crystal display of claim 7, further comprising a color filter disposed between said switch and said liquid crystal layer, and said first electrode being disposed between said color filter and said switch.

12. The liquid crystal display of claim 7, further comprising a color filter disposed between said switch and said liquid crystal layer, and said first electrode being disposed between said color filter and said liquid crystal layer.
